(19) United States
(12) Patent Application Publication
(10) Pub. No.: US 2022/0288977 A1
(43) Pub. Date: Sep. 15, 2022

(54) ADJUSTABLE POSITION ROTARY UNION

(71) Applicant: Equalaire Systems, Inc., Corpus Christi, TX (US)

(72) Inventor: Mark Kevin Hennig, Corpus Christi, TX (US)

(21) Appl. No.: 17/634,192

(22) PCT Filed: Aug. 12, 2020
(86) PCT No.: PCT/US2020/046003

§ 371 Date: Feb. 9, 2022

Related U.S. Application Data
(60) Provisional application No. 62/885,637, filed on Aug. 12, 2019.

(51) Int. Cl. B60C 23/00

(52) U.S. Cl. CPC B60C 23/00327; B60C 23/00345

(57) ABSTRACT

A rotary union for a tire inflation system includes a body having a first end and a second end, the first end comprising threads for threaded coupling to a hubcap, the body forming a fluid channel extending from the first end to a surface of the body; a sleeve rotatably disposed on the body, the sleeve comprising a hose connection port, the sleeve being sealed to the body such that fluid may flow along a sealed path from the fluid channel to the hose connection; and a tubular member having a first end sealingly disposed in the fluid channel at the first end of the body.

### CROSS REFERENCE TO RELATED APPLICATION

This application claims priority to U.S. Provisional Patent Application 62/885,637 titled “Adjustable Position Rotary Union” filed Aug. 12, 2019, which is hereby wholly incorporated herein by reference.

### FIELD

This application relates generally to tire inflation systems and components thereof.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

Automatic tire inflation systems (ATIS) may be used to control vehicle tire pressure by adding fluid to one or more vehicle tires as needed during vehicle operation. An automatic tire inflation system may include a rotary union generally configured to convey pressurized fluid from a vehicle-mounted fluid supply to rotating or rotatable tires. The rotary unions may, for example, be threadably mounted within a hubcap of a vehicle or a rotary union may be mounted to a hubcap using another type of connection that does not permit rotational adjustment of the rotary union to align a rotary union hose connection with a tire valve. Likewise, hubcaps may commonly be attached to a wheel hub using a connection that does not permit rotational adjustment. Accordingly, installation and maintenance of ATIS systems may commonly involve over-tightening or under-tightening a rotary union connection to a hubcap increasing risk of damage to the rotary union and associated ATIS components.

There is a need for a rotary union that allows for ready positioning of a hose connection with respect to a tire valve.

### SUMMARY

A rotary union for a tire inflation system, the rotary union comprising a body having a first end and a second end, the first end comprising threads for threaded coupling to a hubcap, the body forming a fluid channel extending from the first end to a surface of the body; a sleeve rotatably disposed on the body, the sleeve comprising a hose connection, the sleeve being sealed to the body such that fluid may flow along a sealed path from the fluid channel to the hose connection; and a tubular member having a first end sealingly disposed in the fluid channel at the first end of the body.

### BRIEF DESCRIPTION OF THE DRAWINGS

FIG. 1 is a perspective view of a vehicle with an installed inflation system.

FIG. 2 is a partial section view a hubcap with a rotary union attached.

FIG. 3 is a section view of a rotor body and rotatable sleeve, a tubular member being further disposed within the rotor body.

FIG. 4 is an exploded view of a rotor body and rotatable sleeve with a tubular member disposed within the rotor body.

FIG. 5 is an exploded view of a rotor body and rotatable sleeve with a tubular member disposed within the rotor body, and a hubcap.

FIG. 6 is a section view of a rotor body and rotatable sleeve with a tubular member disposed within the rotor body, and a vent shield.

### DETAILED DESCRIPTION

This disclosure is generally related to rotary unions and automatic tire inflation systems including rotary unions. A rotary union may be disposed so as to help convey pressurized fluid from a vehicle-mounted fluid supply to rotating or rotatable tires. For example, a rotary union may be mounted in a hubcap and may include components for communicating fluid from a pressurized vehicles axle to an outlet port, the outlet port being configured to rotate with the hubcap in vehicle operation. A hose connection may then be used to route fluid from the outlet port to a tire valve of a rotatable tire. The rotary unions described herein may further include a rotatable sleeve. Such rotatable sleeves are configured to help align the outlet port of a rotary union with a tire valve. Accordingly, a rotary union including a rotatable sleeve may be secured to a hubcap without aligning the outlet port with a tire valve. After the rotary union is secured to the hubcap, the rotary union may be rotated using the sleeve so that the outlet port is aligned with the tire valve. Advantageously, this may simplify installation of rotary unions and prevent inadvertent damage to inflation system components during installation or maintenance.

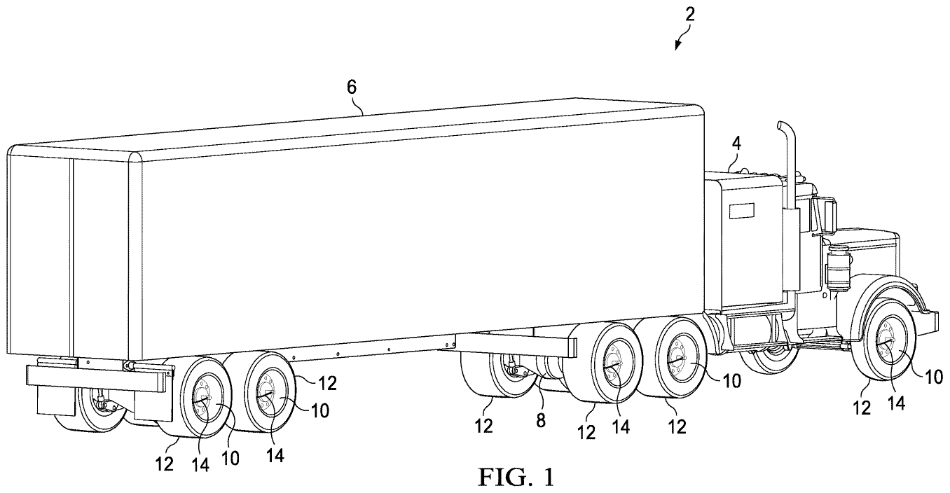

A rotary union including a rotatable sleeve may be included in a commercial truck or other vehicle, such as shown in FIG. 1. As shown therein, a vehicle 2 may comprise a truck 4 and a trailer 6. The truck 4 may include one or more drive axles 8 as part of the vehicle's powertrain. The truck 4 may further include a steer axle (not shown in detail) having pivotable spindles that may provide steering capability for the vehicle 2. The trailer 6 may include one or more fixed axles (not shown). Each axle may have one or more wheels 10 mounted thereto. A pneumatic tire 12 may be mounted to each wheel 10. An axle may terminate in a wheel end. The wheel end may include a spindle and hubcap, for example. In some embodiments, rotary unions including a rotatable sleeve may be used with any of the various types of axles described herein or with other suitable axles.

The vehicle 2 may be provided with an automatic tire inflation system that may use pressurized air from the vehicle's air brake system or some other source of pressurized air to maintain the tires at a desired air pressure. For example, pressurized air may be directed along or through an axle and routed to a rotary union mounted in a hubcap. A rotary union may communicate fluid to one or more air hoses 14. The hoses 14 may communicate fluid to and from the tires 12. The tire 12 may, for example, be a standard single tire or a wide-base tire, such as a super-single tire, as used in commercial vehicles.

An automatic tire inflation system may further include other components, including, for example, a pressure regulator (not shown). In some embodiments, a pressure regulator may be mounted in a sealed control box including an electronic control board and processor suitable for controlling the pressure regulator. The pressure regulator may receive pressurized fluid from a fluid pressure source such as a vehicle air brake system air supply or a step-up or booster pump. The pressure regulator may control the pressure of fluid from the fluid pressure source so as to provide fluid pressure at a level suitable for inflating the tires, such as, for example, a fluid pressure of 110 psi. Pressurized fluid may flow from the pressure regulator through a conduit to the axles. From there, the fluid may flow through conduit fluid lines in or along the axle, or through the axle (if sealed) to a rotary union to a hose to a tire valve connected to the tire.

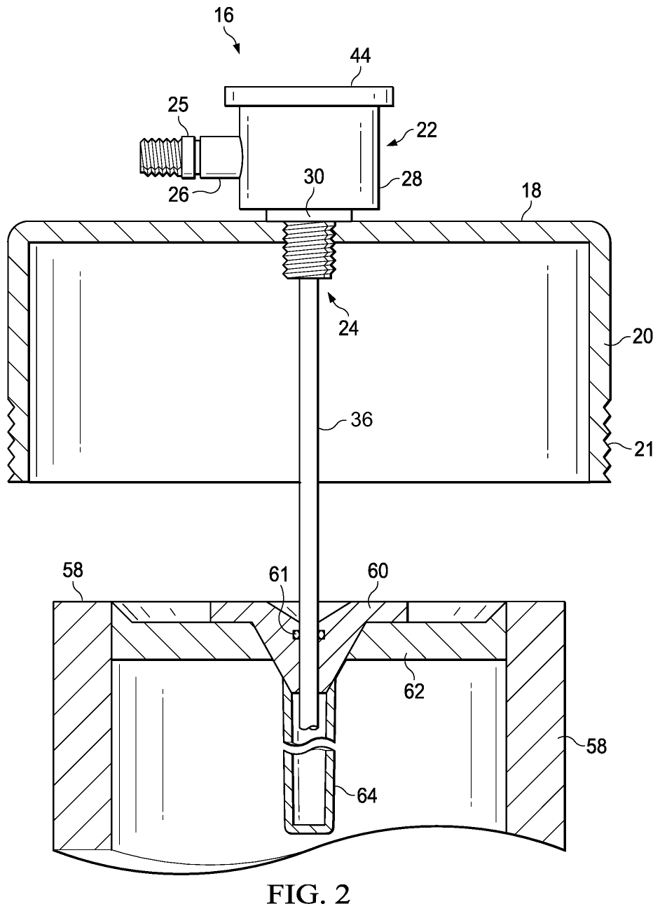

One embodiment of such a rotary union 16 is shown FIG. 2. As shown therein, the rotary union 16 may be mounted to the hubcap 20. Rotary union 16 may route fluid from the axle 58 to hose connection port 26. Port 26 may sealingly communicate fluid to an air hose 14 (as shown in FIG. 1). The rotary union 16 may include a rotatable part including a tubular member 36. The tubular member 36 may be coaxially extendable and translatably disposed in the axle 58. For example, one end of tubular member 36 may sealably engage a first annular seal 61 disposed in the stator 60. The stator 60 may, for example, couple to a press plug 62 which is in turn sealingly disposed at an open end of the axle 58. An air filter 64 may further be disposed at an end of the stator 60. Alternatively, in other embodiments, annular seal 61 may be directly disposed in the axle 58. The first annular seal 61 may be a rotating or non-rotating seal and provide a pivotable or non-pivotable sealing engagement with the tubular member 36. For example, the tubular member 36 may be pivotably and translatably disposed in the first annular seal 61 to accommodate wheel runout. In other words, depending on the configuration of the annular seal 61, the tubular member 36 may or may not rotate in the seal 61.

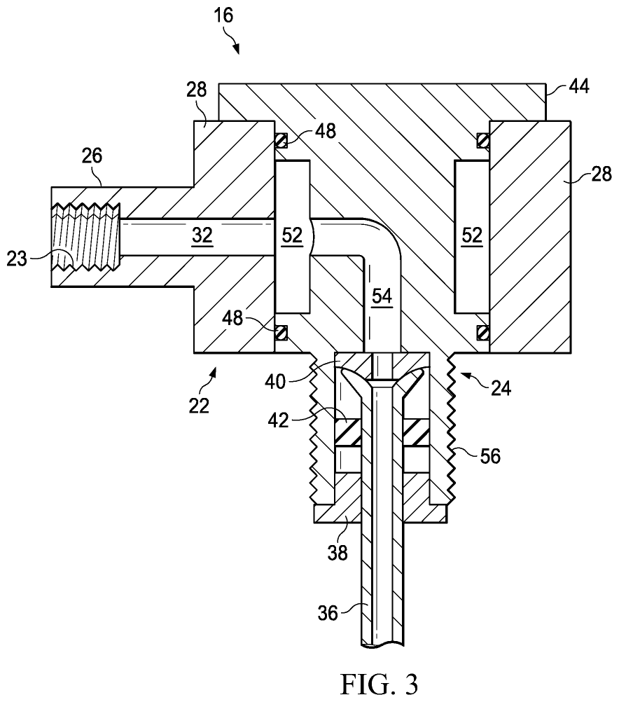

Another end of the tubular member 36 may sealingly engage the rotor body 24. For example, with reference to FIG. 3, tubular member 36 may be disposed within a second annular seal 42. The second annular seal 42 may be a rotating or non-rotating seal and provide for pivotable or non-pivotable sealing engagement. For example, the tubular member 36 may be pivotably disposed in the second annular seal 42 to accommodate wheel runout. Depending on the configuration of the second annular seal 42, the tubular member 36 may or may not rotate in the seal 42. However, the tubular member 36 may rotate in at least one or the other of annular seals 61 and 42, if not in both. The tubular member 36 may be rigid, or flexible, or may include both a flexible portion and a rigid portion. The tubular member 36 may also include a flexible joint or coupling (not shown). The annular seals 61, 42 may comprise o-rings, washers, lip seals, face seals, or any suitable sealing interface, and may comprise a variety of materials, such as rubber, silicone, graphite, and steel or any other suitable sealing material or interface. In some embodiments, an end of the tubular member 36 may be flared to provide a bearing surface for contact with a bearing 40. A telescope cap 38 may be used to retain the tubular member 36, bearing 40 and annular seal 42 in the rotor body 24. Pressurized fluid, such as from the vehicle pressure source, may flow through the tubular member 36 into the fluid channel 54, through the hose connection port 26, and to an air hose for delivery to a tire. The annular seal 42 will substantially prevent pressurized fluid from leaking between the tubular member 36 and the rotor body 24.

The rotatable sleeve 22 generally includes hose connection port 26 and a sleeve body 28. Hose connection port 26 may have a threaded portion 23 for removably attaching an air hose adapter 25 to the hose connection port 26 and a port channel 32 to facilitate fluid communication between the rotor body 24 and the air hose 14 (shown in FIG. 1). In some embodiments, air hose adapter 25 may be a poppet adapter. A poppet adapter prevents air flow through the hose connection port 26 when a hose is not connected to the rotary union. The poppet adapter may then serve as a one-way valve that is normally closed, but be maintained in an open position when an air hose 14 is coupled between the hose connector port 26 and a tire valve stem. When the air hose is disconnected from the hose connector port 26, then the poppet will close, thus preventing fluid from escaping through the hose connection port 26 to atmosphere. In some embodiments, the air hose adapter 25 may be integrated into the hose connection port 26 so as to be a unitary component of the air hose adapter 25 shaft.

The bearing 40 may protect the end of the tubular member 36 from damaging the rotor body 24 should translation occur inside the cavity. The bearing 40 may include a bearing channel to permit fluid to flow from the tubular member 36 to the fluid channel 54 of the rotor body. The flared end 46 of the tubular member 36 may thus be disposed adjacent to the bearing 40 with an annular seal 42 and the telescope cap 38 sealing the rotor body 24 from the external environment. Upon coupling of the rotary union 16 to the hubcap 20, the tubular member 36 may be sealingly coupled to a stator 60 in the axle or to a fluid conduit.

In other embodiments, a rotor body 24 may comprise a tubular member 36 having one end thereof sealingly disposed in a fluid channel of the rotor body. A graphite bearing may be disposed in the rotor body 24 against the end of the tubular member 36 such that the interface of the end of the tubular member 36 and the graphite bearing forms a rotary face seal. Pressurized fluid, such as from the vehicle pressure source, may flow through the tubular member 36 into the fluid channel, through the hose connection port, and to an air hose for delivery to a tire. The face seal will substantially prevent pressurized fluid from leaking between the tubular member and the rotor body.

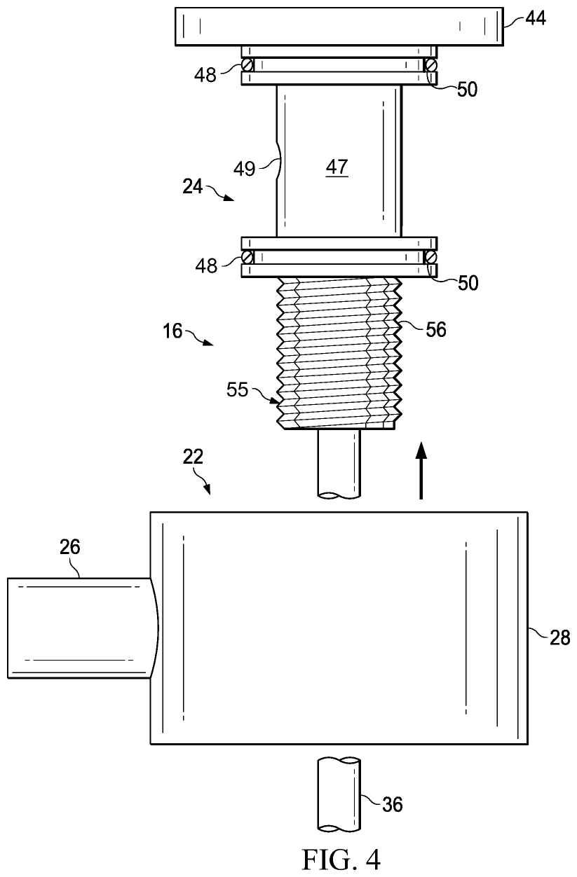

As may be seen in FIGS. 3 and 4, the rotor body 24 comprises a generally cylindrical body about which the sleeve 22 may rotate. The rotor body 24 forms a fluid channel 54 extending from one end 55 to a surface 47, thus forming a fluid opening 49 in the rotor body surface 47. Annular seal 48 is disposed about the rotor body on each side of the fluid opening 49. The annular seals 48 seal the sleeve 22 to the rotor body 24 when the sleeve 22 is disposed in the rotor body 24. Fluid flowing form the fluid opening 49 may thus flow around the rotor body surface 47 toward the hose connector part 26 of the sleeve 22.

The sleeve body 28 is configured to receive the rotor body 24, such that the rotor body 24 may rotate within the sleeve body 28. The rotor body 24 may include an end cap 44 sized to prevent the rotatable sleeve 22 from sliding off the rotor body 24 when the rotary union 16 is mounted to the hubcap 20. For example, during installation of the rotary union 16 to the hubcap 20, the sleeve body 28 may be disposed on the rotor body 24 so that the sleeve body 28 is positioned adjacent the end cap 44. A retaining ring 30 may further be added to hold the disposed sleeve 22 and rotor body 24 together during installation. For example, the sleeve body 28 of the rotatable sleeve 22 may be disposed on the rotor body 24. A retaining ring 30 may then be installed on the threaded potion 56 of the rotor body 24 to hold the sleeve 22 and rotor body 24 together. The resulting structure, including, the rotatable sleeve 22, rotor body 24 and retaining ring 30, may then be installed within the hubcap 20, as shown in FIG. 2, for example. Alternatively, annular seals 48 may provide sufficient friction between the rotor body 24 and the sleeve 22 so as to retain the sleeve 22 on the rotor body 24. In such an embodiment, a retaining ring 30 may not be required.

In another embodiment, the end cap 44 may be removed from the rotor body 24 to allow the rotatable sleeve 22 to be disposed or removed from the rotor body 24 when the rotor body 24 is mounted to the hubcap 20. Alternatively, the end cap 44 may be positioned on an opposite end of the rotor body 24 so that the sleeve body 28 rests upon the end cap following the insertion of the sleeve body 28 over the top of the rotor body 24. A retaining ring 30 or retaining clip may then be positioned above the rotatable sleeve 22 and rotor body 24. Thus, various ways of mounting the rotatable sleeve 22 and rotor body 24 are contemplated as may be appropriate for joining a rotatable sleeve 22 and rotor body 24 at different stages when installing a rotary union 16 at a wheel end.

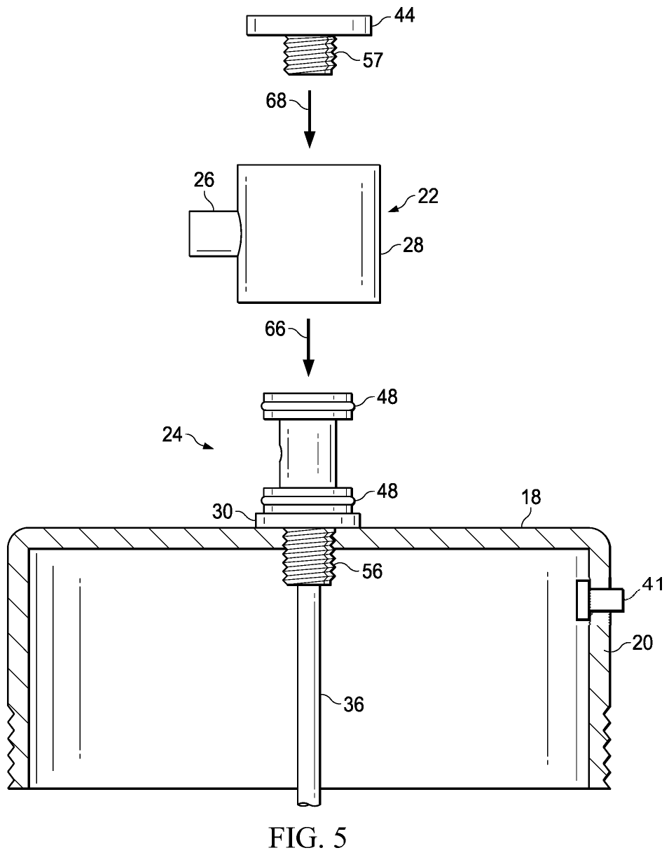

As explained above, rotatable sleeve 22 may be disposed on the rotor body 24, either from one end or the other end of the rotor body 24, and the combination of the rotatable sleeve 22 and rotor body 24 may be installed within the hubcap 20. Alternatively, as shown in FIG. 5, rotor body 24 may already be mounted to the hubcap 20 and ready for installation of rotatable sleeve 22. For example, rotatable sleeve 22 may be disposed over the rotor body 24 as shown in FIG. 5 (see arrow 66). In an installed position, the rotor body 24 may be disposed adjacent retaining ring 30, which may include a bushing and allow for rotational movement between the sleeve body 28 and rotor body 24. A cap bushing (not shown) may also be disposed between the rotatable sleeve 22 and the removable end cap 44. After the rotatable sleeve body 22 has been disposed on the rotor body 24, a removable end cap 44 may be positioned (shown by arrow 68) and threadably attached using the threads 57 to the rotor body 24. Alternatively, the removable end cap 44 may be attached to the rotor body 24 in some other suitable way, such as by push-and-turn lock, magnets, barbs, or a friction interface.

The sleeve body 28 is rotatable about the rotor body 24. For example, the sleeve body 28 and rotor body 24 may be frictionally engaged such that the sleeve body 28 may rotate about the rotor body 24 by application of hand strength or use of a hand tool. In other embodiments, sleeve body 28 may rotate freely on one or more bearings (not shown) or the annular seals 48 may provide only a small amount of friction and the sleeve body 28 may rotate with only a minimal force. In some embodiments, the outer geometry of the sleeve body 28 may be generally square or rectangular so as to create flat areas for gripping when adjusting the orientation thereof to facilitate mating of an air hose to the hose connection port 26 or to an associated air hose adapter 25. Alternatively, retaining ring 30 may be shaped so that it may be gripped when adjusting the rotational position of the sleeve 22. Other exterior geometries may also be suitable. Other features for improving gripping the sleeve 22 may be implemented in other embodiments. For example, a knurled outer surface on the sleeve body 28 may be employed.

In some embodiments, the sleeve body 28 may be rotated with respect to the rotor body 24 such that the hose connection port 26 is in a desired orientation, and then the sleeve body 28 may be fixed or at least suitably tightened to prevent unwanted rotation with respect to the rotor body 24. For example, retaining ring 30 which may be washer, nut, bushing, or other suitable structure. In the embodiment shown in FIG. 2, the retaining ring 30 may be positioned adjacent an outboard face 18 of the hubcap 20. The retaining ring 30 may be used to ensure that the hose connection port 26 remains in a desired position relative a tire valve (not shown) to permit ready installation of an air hose (not shown) to connect the hose connection port 26 and/or air hose adapter 25 to the tire valve. For example, the sleeve body 28 may be rotated so that the hose connection port 26 is facing a tire valve and then the retaining element 30 tightened to ensure the position is maintained when connecting the air hose to a tire valve.

In other embodiments, sleeve body 28 placement may be ensured by tightening the rotary union 16 firmly against the hubcap outboard face 18 and thus introducing a compressive force between the hubcap 20 and end cap 44 of the rotor body 24. For example, as shown in FIG. 2, the end cap 44 may be positioned on outboard end of the rotatable sleeve 22 away from outboard face 18. By allowing the sleeve body to rotate with respect to the rotor body, the position of the air hose connection port 26 can be adjusted to align with a tire valve without risking of under-tightening or overtightening the hubcap or rotary union. A threaded hubcap may, therefore, be tightened to a desired position (e.g., a position to prevent leakage) without considering the orientation of the hose connection port 26 to a tier valve, and the sleeve 22 may then be rotated to better align the hose connection port 26 with the tire valve.

The rotor body 24 may have an end cap 44 so as to allow for a grip point for threading the rotor body 24 into a hubcap 20. The end cap 44 may be integrally connected to the rotor body 24 or may be removable from the rotor body 24. In some embodiments, the end cap 44 may be hexagonal but other cap geometries may be implemented. In some embodiments, the end cap 44 may be configured to facilitate initial threading by hand. The end cap 44 may include one or more surfaces or voids shaped for applying a tool during final tightening. The end cap 44 may also prevent the sleeve body 22 from sliding off of the rotor body 24. Alternatively, cap 44 may be positioned adjacent the outboard face 18 of the hubcap 20. In that embodiment, retaining element 30 may be used to secure the rotatable sleeve 22 and the rotor body 24 together.

Annular seals 48 are disposed about the rotor body 24 so as to seal the sleeve 22 to the rotor body 24. For example, seals 48 may be disposed on each side of a flow channel 52. The seals 48 may be O-rings, lip seals or of another suitable seal configuration, and may comprise a variety of materials, such as rubber, silicone, nylon, oilite or graphite. In some embodiments, one or more of the seals 48 may be seated in annular grooves 50 in a shoulder formed on the rotor body 24. In another embodiment, seals may be seated in annular grooves disposed on an inner surface of rotatable sleeve 28. The rotor body 24 may have a flow channel 52 disposed thereabout. The flow channel 52 is in fluid communication with the fluid channel 54 in the rotor body 24. A fluid channel 54 formed in the rotor body 24 may allow for fluid communication between the tubular member 36 and the flow channel 52. When the sleeve body 22 is assembled with the rotor body 24, the flow channel 52 is also in fluid communication with the port channel 32 in the hose connection port 26.

The flow channel 52 may comprise a gap formed between the rotatable sleeve 28 and the rotor body 24. The gap may be bridged by seals 48. For example, in some embodiments, the flow channel 52 may be formed in an inner surface of the sleeve body 28. For example, the flow channel 52 may be formed in the surface facing the rotor body 24 when the sleeve body 28 is disposed about the rotor body 24. In yet other embodiments, the flow channel 52 may be formed in both the sleeve body 28 and the rotor body 24. The flow channel may be configured to permit fluid to flow between the fluid channel 54 of the rotor body 24 and the fluid channel 32 of the hose connection port 26.

The rotor body 24 may include a threaded portion 56 for removable coupling to the hubcap 20. In some embodiments, a washer or bushing may be disposed between the sleeve body and the end cap 44. In yet other embodiments, a washer or bushing may be disposed between the sleeve body 28 and the hubcap 20 when the rotary union 16 is mounted to the hub cap 20.

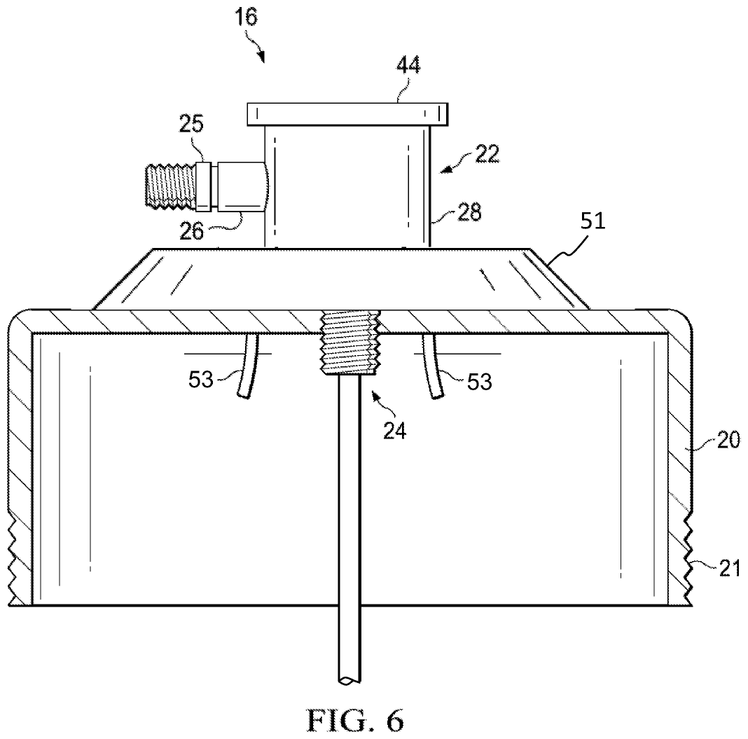

In some embodiments, a pressure relief valve 41 (as shown in FIG. 5) may also be installed in a wall or face of the hubcap 20 so as to vent an excess pressure event from the interior of the hubcap 20. Such a relief valve 41 could be a one-way valve such as a duckbill valve, non-return valve, ball check valve, or other style of check valve wherein materials are only allowed to pass from the interior of the hubcap 20 to the exterior of the hubcap 20. Such an excess pressure event may be initiated through a leak of the tire inflation components, overheating, or other events that may increase the pressure of the interior of a hubcap 20. In such an embodiment, it is not necessary to shield the vent to prevent contaminants from entering through the vent 41 and the fit at the hubcap-rotary union interface may be of a close tolerance to attenuate the possible ingress of contaminants at said interface. However, a vent shield 51 as seen in FIG. 6 may be added as an optional configuration when there may be concern the hubcap-rotary union interface would provide an ingress path for contaminants.

In other embodiments, pressure in the interior of the hubcap 20 may be released by means of one or more vents 53 disposed adjacent to rotary union. The vents 53 allow pressure in the hubcap 20 to be released to atmosphere. The vents 53 may comprise an open tube that is curved so that lubricant may be flung from the end of the tube by centrifugal force when the hubcap 20 rotates with the tire as the vehicle is traveling on a road. The rotary union may be provided with a vent shield 51 and flexible flapper disk. The vent shield 51 may be disposed over the vents 53 to prevent contaminants from entering the hubcap interior. A flapper disk may be disposed between the vent shield 51 and the vent tubes so as to substantially seal the vents 53. As fluid is released from the hubcap, the flapper disk may flutter away from the hubcap 20 so as to allow the pressurized fluid to escape. For highly-pressurized hubcaps, the fluid flowing from the vents 53 to atmosphere may cause the flapper disk to flutter with sufficient violence to cause a loud noise, thus permitting a driver to detect the wheel end having the pressurized hubcap more readily.

The disclosed rotary union 16 may be particularly useful for hubcaps that do not provide for ready or convenient rotational adjustment, such as the hubcap 20 which may be threadably joined to the wheel end hub. A threaded connection 21 may, for example, be disposed at an external surface of the hubcap 20 while in other embodiments a threaded connection may be disposed at an internal surface of the hubcap 20. The rotary union 16 may, for example, be threadably mounted to the hubcap 20 in the outboard face 18 of the hubcap 20. Such threaded connection may utilize any type of threading such as National Pipe Threads, British Standard Pipe Threads (Parallel or Tapered), Unified threading of any pitch, Metric threads (Parallel or Tapered), or any other suitable thread type.

Threaded hubcaps generally do not permit ready rotational adjustment of the hubcap to align a rotary union hose connection with a tire valve without increasing risk of over- tightening or under-tightening the hubcap connection to the hub. Similarly, a threaded rotary union connection to a hubcap generally does not permit ready rotational adjustment of the rotary union to align a rotary union hose connection with a tire valve without increasing risk of over-tightening or under-tightening the rotary union connection to the hubcap. Overtightening may result in damage to the threads or render vehicle service difficult. Under-tightening may result in fluid leaking from the hubcap or loss of the hubcap while driving. Thus, when a rotary union having a rotationally-fixed hose connection is securely mounted to the hubcap by a threaded connection, and the hubcap is securely mounted to the hub by threaded connection, the hose connection may not be conveniently oriented toward a tire valve for attachment of an air hose without increased risk of over-tightening or under-tightening. Similarly, other types of connections between a rotary union 16 and hubcap 20 may not permit rotational adjustment or may only be rotationally adjusted with significant effort and/or risk of component damage. For example, rotary union 16 may be joined to a hubcap using a threaded or non-threaded connection and a connector (e.g., a locknut, swage nut, or c-clip), added on the inside of the hubcap 20, or the rotary union may be fixed to the hubcap 20 in some other suitable way sufficient for providing strength and durability. Advantageously, the rotary union 16 does not need to provide for relative rotation between the rotary union 16 and the hubcap 20 so as to facilitate hose connection alignment. Rather, a hose connection of a rotary union 16 as disclosed herein may be rotated toward a tire valve for ready attachment of an air hose.

In some embodiments, a seal may be disposed at the hubcap-rotary union interface. Such a seal may be an 0-ring, lip seal or any other suitable seal configuration, and may comprise a variety of materials, such as rubber, silicone, nylon, oilite or graphite. It may be valuable to provide a connection at the hubcap-rotary union interface so that components may be rotated without risking damage or removal of seal components. The hose connections described herein may allow ready rotational adjustment without risk of damage to underlying seals, such as may otherwise occur if seals are subject to overtightening of the rotary union 16 to the hubcap 20, or if removed or inadvertently exposed to dirt or other contaminants during adjustment.

The disclosed rotary union is useful for wheel ends having a single tire. However, it may be readily adapted to wheel ends having two or more tires by adding an appropriate number of hose connection ports to the sleeve body. Similarly, while the disclosed rotary union is particularly useful for wheel ends using threaded hubcaps, it may be used for wheel ends having bolt-on hubcaps or hubcaps joined to a wheel end in other ways.

Although the disclosed subject matter and its advantages have been described in detail, it should be understood that various changes, substitutions and alterations can be made herein without departing from the subject matter as defined by the appended claims. Moreover, the scope of the present application is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. For example, although the disclosed apparatus, systems and methods may be described with reference to a manual or manually-activated pressure reduction valve, an electric valve or other automatic electronic or mechanical valve may be used to accomplish relatively rapid reduction of air pressure. Accordingly, the appended claims are intended to include within their scope such processes, machines, manufacture, compositions of matter, means, methods, systems or steps.

What is claimed is:

1. A rotary union for a tire inflation system, the rotary union comprising:
a body having a first end and a second end, the first end comprising threads for threaded coupling to a hubcap, the body forming a fluid channel extending from the first end to a surface of the body;
a sleeve rotatably disposed on the body, the sleeve comprising a hose connection port, the sleeve being sealed to the body such that fluid may flow along a sealed path from the fluid channel to the hose connection; and
a tubular member having a first end sealingly disposed in the fluid channel at the first end of the body.

2. The rotary union of claim 1, the fluid channel forming a flow port at the surface of the body, the sleeve being sealed to the body by a first annular seal and a second annular seal each disposed circumferentially about the body, the first annular seal being between the flow port and the first end of the body, and the second annular seal being disposed between the flow port and the second end of the body.

3. The rotary union of claim 2 further comprising a flow channel in fluid communication with the flow port and with a hose connection port, the flow channel being between the surface of the body and the surface of the sleeve facing the body, the flow channel being disposed such that fluid may flow between the flow port and the hose connection port regardless of rotational orientation of the sleeve with respect to the body.

4. The rotary union of claim 2, the first annular seal and second annular seal each being either an o-ring or lip seal.

5. The rotary union of claim 4, the body further comprising a cap disposed at the second end to retain the sleeve on the body when the rotary union is mounted to the hubcap.

6. The rotary union of claim 5, the cap being removable from the body.

7. The rotary union of claim 5, further comprising a first bushing disposed at a first end of the sleeve.

8. The rotary union of claim 7, further comprising a second bushing disposed between a second end of the sleeve and the cap.

9. The rotary union of claim 6, further comprising a third annular seal sealing the tubular member to the body, the tubular member being rotatable and pivotable with respect to the body.

10. The rotary union of claim 4 further comprising a bearing disposed between the first end of the tubular member and the body.

11. The rotary union of claim 10, the first end of the tubular member being flared.

12. The rotary union of claim 11, further comprising a telescope cap disposed in the fluid channel about the tubular member so as to retain the first end of the tubular member in the body.

13. The rotary union of claim 4, further comprising a graphite bearing non-rotatably disposed in the fluid channel at the first end of the tubular member, the first end of the tubular member and the graphite bearing forming a rotary face seal, the tubular member being rotatable with respect to the body.

14. The rotary union of claim 1 further comprising a retaining ring for holding the body and the sleeve together.

15. The rotary union of claim 1 further comprising a retaining ring;
wherein the retaining ring may be adjusted to fix the body and sleeve in a desired orientation.

16. The rotary union of claim 15 wherein the retaining ring, the retaining ring being configured to hold the body and the sleeve together.

17. The rotary union of claim 1 wherein the rotatable sleeve includes an outer surface with a geometric shape for gripping the rotatable sleeve.

18. The rotary union of claim 1 wherein the rotatable sleeve includes a knurled outer surface.
